(19) United States
(12) Patent Application Publication
(10) Pub. No.: US 2011/0295857 A1
(43) Pub. Date: Dec. 1, 2011

(54) SYSTEM AND METHOD FOR ALIGNING AND INDEXING MULTILINGUAL DOCUMENTS

(76) Inventors: Ai Ti Aw, Singapore (SG); Min Zhang, Singapore (SG); Lian Hau Lee, Singapore (SG); Thuy Vu, Singapore (SG); Fon Lin Lai, Singapore (SG)

(21) Appl. No.: 13/000,260

(22) PCT Filed: Jun. 20, 2008
(86) PCT No.: PCT/SG08/00220

§ 371 Date: Apr. 28, 2011

(51) Int. Cl. G06F 17/30

(52) U.S. Cl. 707/739; 707/741; 707/743; 707/E17.008; 707/E17.083; 707/E17.089

(57) ABSTRACT

A system and method for aligning multilingual content and indexing multilingual documents, to a computer readable data storage medium having stored thereon computer code means for indexing multilingual documents, to a system for presenting multilingual content. The method for aligning multilingual content and indexing multilingual documents comprises the steps of generating multiple bilingual terminology databases, wherein each bilingual terminology database associates respective terms in a pivot language with one or more terms in another language; and combining the multiple bilingual terminology databases to form a multilingual terminology database, wherein the multilingual terminology database associates terms in different languages via the pivot language terms.

### FIELD OF INVENTION

The present invention relates broadly to a system and method for aligning multilingual content and indexing multilingual documents, to a computer readable data storage medium having stored thereon computer code means for aligning and indexing multilingual documents, and to a system for presenting multilingual content.

### BACKGROUND

One of the key factors affecting the accessibility of global knowledge is the variety of languages information is provided in. Without a systematic and holistic approach to organize and manage this multilingual information, a searcher can be restricted in the scope of information received.

Bilingual terminology databases or machine translation systems are the most crucial resources to link information between languages. To construct bilingual terminology databases manually is labour-intensive, slow and usually with narrow coverage. Although recent advances in corpus-based techniques have spawned many studies and researches in acquiring these resources statistically, the main limitation of such techniques lies in the heavy reliance of large parallel corpus. These parallel corpuses are however, difficult to collect and are not available for many languages.

Similarly, the current state-of-the-art machine translation systems are either developed using large parallel corpus or built for restricted domain with limited vocabularies. These systems normally do not provide satisfactory translations for the dataset that the users are interested in. This restrains accurate and relevant information from being retrieved and used.

Therefore, there exists a need to provide a system and method for multilingual information access to address one or more of the problems mentioned above.

### SUMMARY

In accordance with a first aspect of the present invention there is provided a method for aligning multilingual content and indexing multilingual documents, the method comprising the steps of generating multiple bilingual terminology databases, wherein each bilingual terminology database associates respective terms in a pivot language with one or more terms in another language; and combining the multiple bilingual terminology databases to form a multilingual terminology database, wherein the multilingual terminology database associates terms in different languages via the pivot language terms.

The method may further comprise indexing the multilingual documents such that each multilingual document is indexed to one or more terms in the pivot language.

Generating the multiple bilingual terminology databases may comprise aligning, for respective bilingual pairs of one of the other languages and the pivot language, the content of documents of each bilingual pair.

Generating the multiple bilingual terminology databases may comprise the steps of pre-processing each of the multilingual documents; extracting respective monolingual terms from each of the pre-processed multilingual documents; aligning, for respective bilingual pairs of one of the other languages and the pivot language, the content of documents of each bilingual pair; and generating the multiple bilingual terminology databases based on extracted respective terms from the aligned documents of each bilingual pair.

Aligning, for respective bilingual pairs of one of the other languages and the pivot language, the content of documents of each bilingual pair may comprise the steps of building up a relationship network comprising a host of bilingual cluster maps; and mining documents with similar content across respective pairs of mapped cluster maps.

The mining of the documents with similar content across respective pairs of mapped cluster maps may comprise assuming a chain of frequencies to be a signal and utilising signal processing techniques such as Discrete Fourier Transform to compare frequency distributions of the respective pairs.

The method may further comprise, for each document of a set of documents with similar content, linking said each document to the other documents in the set.

Indexing the multilingual documents may further comprise using a plurality of monolingual index trees in respective languages such that each multilingual document is indexed to one or more terms in a corresponding monolingual index tree, and wherein each term in the respective monolingual index trees identifies a multilingual index tree object identifying the associated terms in the different languages via the pivot language terms.

In accordance with a second aspect of the present invention there is provided a system for aligning multilingual content and indexing multilingual documents, the system comprising a bilingual terminology database generator for generating multiple bilingual terminology databases, wherein each bilingual terminology database associates respective terms in a pivot language with one or more terms in another language; and a bilingual terminology fusion module for combining the multiple bilingual terminology databases to form a multilingual terminology database, wherein the multilingual terminology database associates terms in different languages via the pivot language terms.

The system may further comprise a multilingual indexing module for indexing the multilingual documents such that each multilingual document is indexed to one or more terms in the pivot language.

The bilingual terminology database generator may comprise a content alignment module for aligning, for respective bilingual pairs of one of the other languages and the pivot language, the content of documents of each bilingual pair.

The bilingual terminology database generator may comprise a pre-processor for pre-processing each of the multilingual documents; a monolingual terminology extractor for extracting respective monolingual terms from each of the pre-processed multilingual documents; a content alignment module for aligning, for respective bilingual pairs of one of the other languages and the pivot language, the content of documents of each bilingual pair; and a bilingual terminology extractor for generating the multiple bilingual terminology databases based on extracted respective terms from the aligned documents of each bilingual pair.

The content alignment module may build up a relationship network comprising a host of bilingual cluster maps; and mines documents with similar content across respective pairs of mapped cluster maps.

The mining of the documents with similar content across respective pairs of mapped cluster maps may comprise assuming a chain of frequencies to be a signal and utilising signal processing techniques such as Discrete Fourier Transform to compare frequency distributions of the respective pairs.

For each document of a set of documents with similar content, the content alignment module may further link said each document to the other documents in the set.

The multilingual indexing module may use a plurality of monolingual index trees in respective languages such that each multilingual document is indexed to one or more terms in a corresponding monolingual index tree, and wherein each term in the respective monolingual index trees identifies a multilingual index tree object identifying the associated terms in the different languages via the pivot language terms.

In accordance with a third aspect of the present invention there is provided a computer readable data storage medium having stored thereon computer code means for aligning multilingual content and indexing multilingual documents, the method comprising the steps of generating multiple bilingual terminology databases, wherein each bilingual terminology database associates respective terms in a pivot language with one or more terms in another language; and combining the multiple bilingual terminology databases to form a multilingual terminology database, wherein the multilingual terminology database associates terms in different languages via the pivot language terms.

In accordance with a fourth aspect of the present invention there is provided a system for presenting multilingual content for searching, the system comprising a display; a database of indexed multilingual documents, wherein each multilingual document is indexed to one or more terms in a pivot language and such that terms in different languages are associated via the pivot language terms; wherein the display is divided into different sections, each section representing a plurality of clusters of the indexed multilingual documents in one language; wherein respective clusters in each section are linked to one or more clusters in another section via one or more of the pivot language terms; and visual markers for visually identifying the linked clusters in the different sections.

The visual markers may comprise a same display color of the linked clusters.

The visual marker may comprise displayed pointers between the linked clusters in response to selection of one of the clusters.

The system may further comprise text panels displayed on the display for displaying terms associated with a selected cluster.

The system may further comprise another text panel for displaying links to documents in the selected cluster for a selected one of the displayed terms.

Said another text panel for displaying links to documents may further display, for each document in the selected cluster or returned as search results, links to similar documents in other languages.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows an example embodiment of the multilingual information access system.

FIG. 2 shows the schematic diagram of a Bilingual Terminology Database Generation Module in an example embodiment.

FIG. 3 shows the schematic diagram of an example embodiment of the Monolingual Term Extraction Module.

FIG. 4 shows the schematic diagram of an example embodiment of the Content Alignment Module.

FIG. 5 shows the schematic diagram of an example embodiment of the Multilingual Retrieval Module.

FIG. 6a shows a first sample view of an example embodiment of the presentation module.

FIG. 6b shows a second sample view of an example embodiment of the presentation module.

FIG. 7 shows a sample view of the document display pop-up window in an example embodiment of the presentation module.

FIG. 8 shows the method and system of the example embodiment implemented on a computer system.

FIG. 9 shows the method and system of the example embodiment on a wireless device.

FIG. 10 shows a flowchart illustrating the method for aligning multilingual content and indexing multilingual documents.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “determining”, “creating”, “generating”, processing“, “outputting”, “standardizing”, “extracting”, “clustering”, “fusing”, “indexing”, “retrieving” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

Embodiments of the present invention seek to provide a system and method to facilitate the acquisition of multilingual information more accurately and economically while lessening the reliance on parallel corpus and to have a more accurate translation reflecting the subject domain of the dataset being worked on. This may be achieved through the automatic extraction of bilingual terminologies from existing user datasets or huge online resources, which are in different languages. Coupled with the construction of a multilingual index using the fusion of extracted bilingual terminologies, the proposed framework may support different kinds of multilingual information access applications, for example, multilingual information retrieval.

Embodiments of the present invention offer a generic architecture that is domain and language independent for accurate multilingual information access. They present an inexpensive approach for capturing the translations of multilingual terminologies that are representative to the user domain. Tremendous cost to create parallel text or query translation using user provided datasets can be saved as the framework exploits unsupervised learning for multilingual terminologies acquisition with minimal additional knowledge.

The embodiments further seek to provide a system and method for accessing multilingual information from multiple sets of monolingual corpus in different languages. These monolingual corpuses can be in any language and/or domains and may be similar in content. It may allow accurate multilingual information to be accessed without the use of a well-defined dictionary or machine translation system.

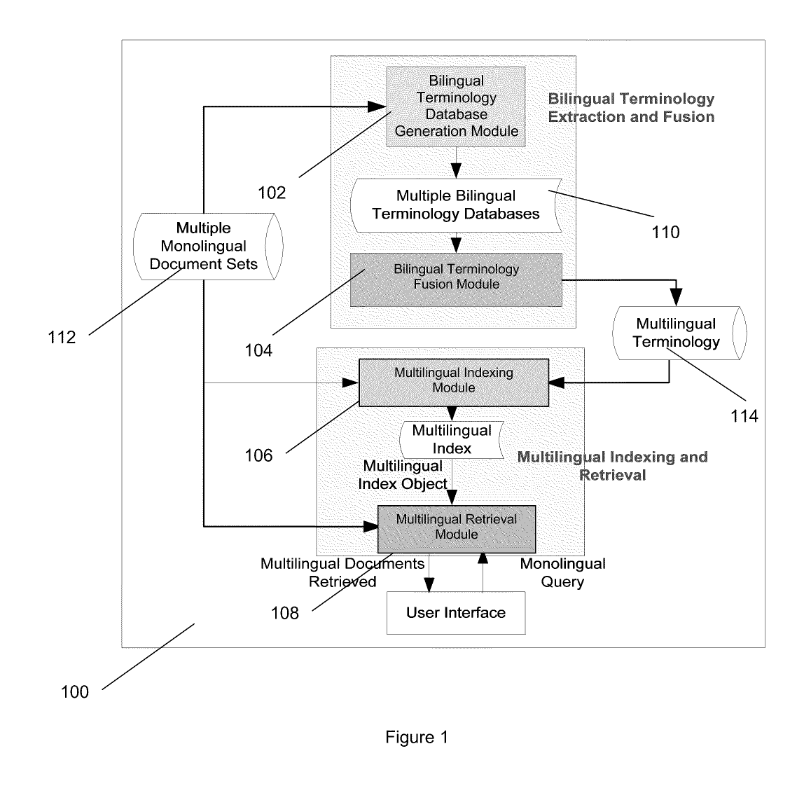

FIG. 1 shows an example embodiment of a multilingual information access system 100. The system comprises of four main modules. The first is the Bilingual Terminology Database Generation module 102 for creating bilingual terminology databases 110 directly from multiple pairs of monolingual corpus 112. The second is the Bilingual Terminology Fusion Module 104 providing the fusion of various bilingual terminology databases 110 to assemble a multilingual terminology database 114. The Multilingual Indexing Module 106 and Multilingual Retrieval Module 108 deal with multilingual indexing and retrieval respectively such that a query entered in one language gets expanded to different languages in the same semantic interpretations and surface representations as they appear in the different corpuses. The Multilingual Indexing is achieved through the use of the multilingual terminology database 114 generated by the Bilingual Terminology Fusion Module 104. As multilingual terminology is derived directly from the corpus, its translation is likely to be more accurate and bound to be found in the corpus.

The components defined in this example embodiment are assigned with specific roles. It will be appreciated by a person skilled in the art that the exemplary system is based on the plug and play model which allows any of the components to be replaced or exchanged without excessive dependency on the knowledge of the other components.

The four main modules constituting the example embodiment of the present invention are discussed in further detail as follows.

### 1. Bilingual Terminology Database Generation Module

In the example embodiments, the Bilingual Terminology Database Generation module 102 automatically extracts bilingual terminologies from two monolingual comparable corpuses through unsupervised learning. The use of the unsupervised training method enables bilingual terminologies to be learnt from user datasets directly.

The input for bilingual terminology database generation module 102 is a set of monolingual comparable corpuses in different languages. A set of comparable corpuses is a set of texts in different languages covering the same topic or domain. It is different from parallel corpuses where documents in the different languages are exact translations of each other. The output is a set of bilingual terminologies extracted from the corpuses to form multiple bilingual terminology databases. These databases are used by the Bilingual Terminology Fusion Module 104 to construct a multilingual terminology database which may remove the need to employ direct translation resources such as machine translation system or bilingual dictionary during retrieval.

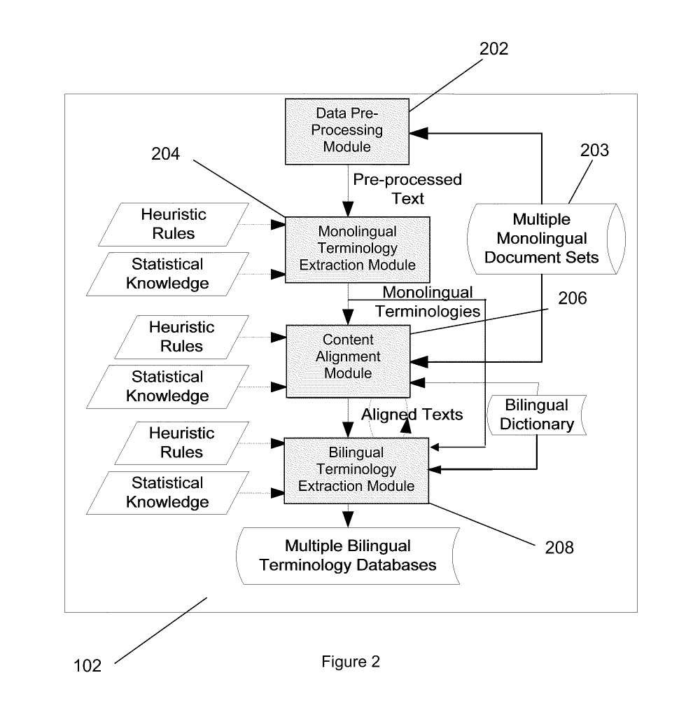

FIG. 2 shows the schematic diagram of a Bilingual Terminology Database Generation Module 102 in an example embodiment, comprising a data pre-processing module 202, a monolingual term extraction module 204, a content alignment module 206, and a bilingual term extraction module 208.

The data pre-processing module 202 pre-processes each of the monolingual documents for each of the multiple monolingual document sets 203 separately for the monolingual terminology extraction module 204 to extract respective monolingual terms from each of the pre-processed monolingual documents. With the extracted monolingual terms associated with each monolingual document for each of the multiple monolingual document sets 203, the content alignment module 206 aligns, for respective bilingual pairs of one of the other languages and a predetermined pivot language, the content of documents of each bilingual pair. For example, given a pivot language of English, documents in Malay, Chinese, etc., are aligned with the documents in English. Finally, the bilingual terminology extraction module 208 generates the multiple bilingual terminology databases based on extracted respective terms from the monolingual terminology extraction module 204 and the content aligned documents from the content alignment module 206.

In the example embodiment, each document is processed by the data pre-processing module 202 and the monolingual terminology extraction module 204 separately with the same algorithm or program processing each of the documents

The data pre-processing module 202 performs data pre-processing, for example data manipulation activities to standardize the text into a specific format, for use by the next module (Monolingual Term Extraction Module 204). The data pre-processing activities may further include but are not limited to encoding scheme standardization, format standardization, etc. It may also further include language detection, spell checking and/or any text processing tasks necessary for text standardization.

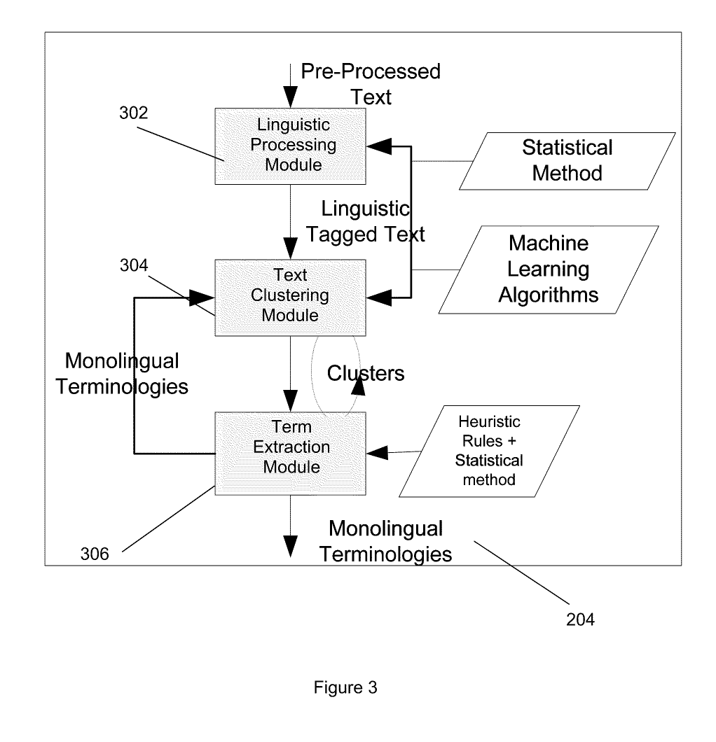

The pre-processed or standardised text is then fed into the Monolingual Terminology Extraction module 204 which, in turn extracts a list of monolingual terminologies representing the keywords e.g. vocabularies, jargons or phrases, used to convey the main idea or message of the documents. FIG. 3 shows the schematic diagram of an example embodiment of the monolingual term extraction module 204 (FIG. 2) comprising a Linguistic Processing module 302, a Text Clustering Module 304 and a Term Extraction Module 306. The Linguistic Processing Module 302 receives the pre-processed text from the pre-processing module 202 (FIG. 2) to establish linguistic knowledge to the text using statistical methods and machine learning algorithms and tags the text with this knowledge. The linguistic knowledge includes but is not limited to specific language analysis such as part-of-speech processing and word segmentation. The linguistically tagged text is input into the Text Clustering Module 304 to form monolingual text clusters. These clusters are input into the Term Extraction Module 306 for term extraction based on a set of heuristic rules and statistics. The extracted terms may then be iteratively re-processed by the Text Clustering Module 304 for further text clustering and term extraction. On very large data sets, the iterative use of extracted terms to cluster text followed by further term extraction using the clustered text may provide better terminology extraction. It will be appreciated by a person skilled in the art that known and independent algorithms may be used for clustering and extraction respectively. In the following, Text Clustering and Term Extraction will be described as implemented in the example embodiments.

### Text Clustering

In the embodiments of the present invention, the Text Clustering Module 304 utilises a clustering technique which focuses on a K-means method run on a randomly selected sampling of the monolingual document set, and further classification of other documents to the clusters in a supervised way. In other words, the original clustering task for the large set of monolingual documents is broken into two sub-tasks: a clustering task for a smaller and sampled document set and a classification task for the remaining document set. Multiple K-means runs to decide the cluster centers may be implemented first, before conducting the classification step.

### I. Feature Selection Criteria

In the example clustering technique, any keyword or term occurring within a dataset is also referred to as a feature. The entire population of keywords or terms contained within a dataset itself may be referred to as the candidate feature space. A clustering algorithm is like any other decision-making algorithm in that the original input data (in this case, either the original documents' contents, or their term extraction results) needs to be represented by a finite set of features (i.e. the feature set) in order for the problem to be tractable.

The selection of the feature set to be used to represent all input data and the quality (i.e. the “representative-ness”) of the features within a feature set will significantly influence the eventual performance of the clustering algorithm. The process of selecting this set of features is known typically as feature selection. Feature selection for a clustering algorithm is not directly equivalent to selection for a classification algorithm. This is because in the classification problem, the training of the classifier is supervised, meaning that the relevant topic(s) to be assigned to each document is known a-priori. This information in effect can delineate the different topics in the dataset such that the quality of any prospective feature set can be quantified statistically, i.e. a feature set is “good” if for each topic, there can be obtained a set of features that occurs frequently in all or many of the documents relevant to that topic, while never or infrequently occurring in the documents of all the other topics.

In contrast, in document clustering the a-priori knowledge of document-to-topic mapping is not known in advance, thus preventing the quality of a prospective feature set from being statistically verified before actual clustering. The selection of candidate features for a feature set is thus based on more generic criteria in the example algorithm. The criteria used in selecting the feature sets in the example algorithm fall into the following sub-sections.

### Document Frequency (df)

Document frequency (df) refers to the number of documents that a candidate feature occurs in within a given input dataset. It is usually expressed as a fraction of the total number of documents within the dataset. In text processing, a candidate feature with a lower df is considered better than a candidate feature with a higher df. In other words, the quality of a candidate feature is inversely proportional to its document frequency (i.e. proportional to its inverse document frequency, idf). Mathematically, this may be expressed as either of the relations:

$${quality}_{feature} ∝ \frac{1}{{df}_{feature}} OR {quality}_{feature} ∝ {idf}_{feature} \qquad ( 1 )$$

The argument for adopting the above relationship is that the most common words/terms in a language (e.g. prepositions, pronouns, etc.) tend to occur in almost all documents, giving them very poor discriminating power between any two topics. However, simply selecting the rarest candidate features in terms of df is not feasible. This is because a more frequently-occurring feature improves the likelihood of content overlap between documents which in turn supports the high degree of generalisation required to enable the large number of documents to be clustered to a relatively much smaller set of clusters. In the worst-case scenario of selecting candidate features with low df, the set of features selected could result in every document to be clustered having no features in common with every other document. In view of the above inherent risks in equating low document-frequency candidate terms with good features, a directly proportionally relationship is adopted between the quality of a candidate feature and its document frequency. i.e.:

$${quality}_{feature} ∝ {df}_{feature} OR {quality}_{feature} ∝ \frac{1}{{idf}_{feature}} \qquad ( 2 )$$

To prevent some of the least informative words which may also be the words with some of the highest df to be treated as good features, one or more stop-word lists (see below) containing the commonly-accepted set of such words for each language are also adopted.

### Term Frequency (tf)

Term frequency (tf) refers to the number of times that a candidate feature occurs within a single document. It is usually expressed as a fraction of the total number of words/terms occurring within that document. In the example embodiment, a candidate feature with a higher tf is considered better than a candidate feature with a lower tf. Mathematically, this could be expressed as:

quality_{feature} ∝tf_{feature} (3)

The logic behind such a relationship is that a candidate feature that occurs more frequently within a document has a statistically better probability of representing the main thrust of the document's content, and hence may be more likely to be directly related to the topic that is associated with that document. In addition, ignoring candidate features with low tf helps to avoid selecting words that are actually typographical errors (which will typically have a low tf, but not necessarily a low df).

### Stop-Word Lists

As mentioned earlier, stop-word lists are used in the example algorithm to filter out high document frequency words/terms that nonetheless represent poor features. Some parts-of-speech classes can be well-represented within stop-word lists. For example, for the English language, stop-words can include: pronouns; prepositions; determiners; quantifiers; conjunctions; auxiliaries; and, punctuations. The set of pronouns can include all their different applicable forms, such as: singular, plural, subjective, objective, possessive, reflexive, interrogative, demonstrative, indefinite, auxiliary, etc. Other typical entries within the stop-word list can include: names of months; names of days; and, common titles.

### Maximum Document Frequency

With reference to earlier sections, combining the requirement of high document frequency, with that of non-membership within a stop-word list, can help ensure that only good candidate terms are selected across all documents in a collection. But, it may be difficult to gauge how comprehensive or “correct” a stop-word list is, and that there can often be specialised (i.e. domain-specific) terms occurring at high df within a collection of documents that exist within some technical or specialist field. Examples of these could be: legalese used by lawyers within legal documents; or scientific terms used in research articles. To cater for such situations, a configurable maximum df threshold is added, dfmax that is applied as an additional filter on top of the stop-word lists. The example for the use of dfmax is as such:
a) Suppose a candidate feature has a df of 0.15.
b) This would mean that it is found in 3 out of twenty of all documents in a collection.
c) If such a candidate were to actually be a good discriminant feature between topics, it would imply that there is likely to be a single topic to which roughly 0.15 of all documents belong.
d) At this point, a general expectation on the number of topics and their distribution within the document collection is applied which, in the case of actual datasets, would most likely lead to the conclusion that such a large topic is unlikely to exist.
e) Thus, through negative inference, it may be confidently expected that imposing the restriction that dfmax=0.15 will not result in the loss of any useful features.
The default value of dfmax is set at 0.15, but may be raised or lowered according to the estimations in point (d) above.

### Maximum Global Term Frequency

Similar to maximum document frequency, the concept of a maximum global term frequency threshold, gtfmax is introduced. The global term frequency of a candidate feature is defined as: the total number of occurrences of the candidate feature in all documents in the dataset, divided by the total number of all candidate features counted in all documents in the dataset. Thus, unlike document frequency, term frequency tf cannot be compared directly with gtfmax, since the former is derived from individual documents while the latter is a global limit. A default value of gtfmax of 0.01 is used in the example algorithm. This means any candidate feature that has a total global count that is equal to or more than 1% of the total count of all candidate features contained within an entire dataset is not accepted. The reason for having gtfmax is related to the feature strength weighting formula, described below. It will be seen that the weighting formula adopted places more emphasis in tf strength over df strength. This implies that it can lead to over-emphasizing those candidate features that occur within relatively few documents (i.e. moderately high df, but low gtfmax) because they occur a disproportionately high number of times within those documents (i.e. very high tf). Selection of such candidate features may not be desirable as it may lead to the problem of lack of generalisation potential similar to that arising for df when using of Equation (1) to select df. Thus, gtfmax is introduced with the aim of reducing the probability of such types of candidate features being accepted.

### Minimum Term Length

An additional constraint to feature selection for Chinese language terms is applied in the example embodiment. Single character Chinese terms are widely regarded as being meaningless within the language, but from a linguistic as well as a practical point of view (because there are so many different Chinese characters), cannot be labeled as stop-words either. For this reason, an additional constraint during selection of Chinese language features only in which the minimum length (in terms of Chinese characters) of a candidate feature must be two is added. The issue of minimum term length within the English and Malay datasets is not as crucial as the small set of characters (e.g. 26 letters of the alphabet) can readily be covered within their respective stop-word lists.

### Feature Strength Weighting Formula

A weighting formula for quantifying the quality of any candidate feature such as to allow all candidate features to be ranked globally is also provided. Some pre-determined number (i.e. a top-N) of the best ranked features are then selected to be the finite feature set used to represent all documents input to the clustering algorithm.

The feature strength weighting formula used in the example embodiment is calculated as a weighted sum of five separate (but not necessarily independent) measures, namely:
A=Top document frequency, df, subject to a maximum document frequency of less than 15%;
B=Top term frequency, tf, subject to a maximum global term frequency of less that 1%, plus an additional constraint of minimum term length of two characters for Chinese language features);
C=Top intra-document term frequency, being the maximum frequency of a term found within a single document across all documents containing the term.;
D=Top intra-document term frequency delta, being the difference between the highest and the lowest (non-zero) intra-document term frequency of a term;
E=Top document-to-term twining, being the duplicated df value that is introduced only for those terms which appear exactly once in every document that they occur in. For those terms for which this measure is not applicable, the value defaults to 0 (i.e. no contribution to overall weight by E).

The weighting formula used in the example embodiment is:

(A×0.2)+(B×0.5)+(C×0.8)+(D×1.0)+(E×1.0) (4)

### II. Feature Extraction Criteria

As earlier mentioned, it may be preferred for documents to be represented by a finite set of features in order for them to be processed by any decision-making algorithm. Performing an initial scan through the whole dataset (or some representative part of it), and analysing each keyword that satisfies all restrictions described in “I. Feature Selection Criteria”, the strength of each keyword based on the formula of Equation (4) may be calculated and a list of the top N best features, i.e. the “feature set” may be produced.

Once selected, a feature set in the example algorithm represents the restricted set of keywords with which any document to be clustered can be described. Any words/terms in the original document that are not members of the feature set are ignored; while those found within the document that do belong to the feature set are counted and re-composed into a vector (i.e. a “feature vector”), with each element of the vector representing the occurrence count (within the document) of one unique feature within the feature set. In the example algorithm, the feature vector of some document, x, may be expressed formally as:

x̅={fc₀(x),fc₁(x), . . . fc_{N-1}(x)} (5)

Where: N=the top N best features selected to form the feature set; and,

fcᵢ(x)=number of times that feature i occurs in document x.

The process of breaking down and re-composing any document into a feature vector is commonly referred to as feature extraction.
Inverse Document Frequency (idf)—for Vector Representation

The case was stated above for using a proportional [i.e. Equation (2)] rather than an inversely-proportional [i.e. Equation (1)] relationship when measuring the quality of a candidate feature with respect to its document frequency, df, in the example embodiment. However, once the task of feature selection (Section 3.1) is completed, the option of deciding anew on whether to use Equation (1) or (2) during feature extraction resurfaces.

The reason for this apparent inconsistency in strategy is described as follows:
a) Whereas during the feature selection phase, the concern was in accepting poor features via Equation (1), once feature selection is completed, we may consider the feature set to be fixed and containing only “good” features;
b) One measure of effective feature extraction is that documents belonging to different topics/clusters have feature vectors that are as distinct from one another as possible;
c) Two feature vectors belonging to different topics can be made more distinct from each other by emphasizing those features that are more unevenly distributed between the topics;
d) Statistically, between any two “good” features, the one that has a lower df has a higher probability of being unevenly distributed between topics; and lastly,
e) To give greater emphasis to the more unevenly distributed (between topics) features over the more uniformly distributed ones within a feature vector is equivalent to weighting the features according to their inverse document frequency (i.e. idf). Therefore, Equation (1) is adopted as the primary weighting scheme when representing documents by their feature vectors in the example embodiment. In practical terms this means that a variation of Equation (5) is applied to express the feature vector of each document, i:

x̅={fc₀(x)×idf₀,fc₁(x)×idf₁, . . . ,fc_{N-1}(x)×idf_{N-1}} (6)

Where: idfᵢ=some function proportional to the inverse document frequency of feature i.

### III. Clustering Algorithm

The specific K-means clustering algorithm in the example embodiment selected to perform the document clustering is the K-means variant known as the Randomised Local Search (RLS) algorithm, proposed by Fränti et.al. in “Randomized local search algorithm for the clustering problem” [Pattern Analysis and Applications, 3 (4), 358-369, 2000]. This algorithm was selected as it addresses the typical problem of K-means algorithm being trapped within local minima, but without having to sacrifice on the speed of K-means.

The basic strategy behind the RLS algorithm is that of adopting a modified representation of a clustering solution. A typical clustering algorithm will represent the latest clustering solution derived either in terms of the partition P of the data objects or the cluster representatives C (i.e. the cluster centroids). The reason for this mutual exclusion is that P & C are co-related such that one can always be derived from the other. The RLS strategy is to firstly maintain both P & C, and re-work both the neighbourhood function and original K-mean iteration function to take advantage of having both sets of information available. By taking this approach, the RLS algorithm is able to avoid having to recalculate either P or C from scratch in every step of the algorithm. The second part of the RLS strategy is to generate only one candidate solution per iteration (as opposed to multiple candidates, one for each cluster), and to perform only local repartition between iterations based on the single candidate solution. Using only a single candidate solution, local repartition avoids having to recalculate all P and C values by re-evaluating only the single pair of source-and-target clusters selected by the neighbourhood function.

The RLS algorithm is extended further by introducing the concept of a “voting” or “multi-run” RLS algorithm, termed vRLS. The vRLS algorithm is simply an aggregation of multiple (say M) RLS algorithms each using a different initial random seed value. The initial random seed value determines the hitherto random sequence in which the document set is scanned during cluster induction, which in turn determines which (if any) local minima the algorithm may encounter and hence the “ceiling” at which level the clustering algorithm fails to improve because it has become trapped within one or more local minima.

In the example embodiments, a deterministic cluster composition technique is implemented. The final sets of K clusters produced by each of the M individual runs within vRLS are treated as the candidate nodes of K potentially complete graphs, with each graph ideally comprising of M nodes. Given a vRLS algorithm configured to produce M “voters” or “runs”, the set R representing all the clusters in all the runs may be represented by:

R={Rᵢ:0≦i<M} (7)

Where each run/voter, Rᵢ, produces K clusters of documents and is represented by:

Rᵢ={rᵢcⱼ:0≦j<K (8)

Each node is identified by a pair of indices, being the run, rᵢ, and the (anonymous) cluster index, cⱼ, assigned to the j-th cluster within run i. If we take X as the set of all input documents to the vRLS algorithm, then for each run Rᵢ, the following relationships will hold true:

$$\begin{matrix}{R}_{i} ≡ {⋃}_{j = 0}^{K - 1} {r}_{i} {c}_{j} ≡ X \\ and \text{:} & ( 9 ) \\ {r}_{i 1} {c}_{i} ⋂ {r}_{i 2} {c}_{k} ≡ \{ \} : 0 \leq {r}_{i 1} , {r}_{i 2} < {R}_{i} , 0 \leq j , k < K \\ ∀ i 1 = i 2 , j \neq k & ( 10 )\end{matrix}$$

Conceptually, each of the K potentially complete graphs represents a set of M nodes (one from each run), that best represents a single, shared topic across the M runs. The intricacy of the concept arises when it is taken into consideration that the construction of any one of the K potentially complete graphs is inter-dependent with the construction of every one of the other K-1 graphs. Somewhat counter-intuitively, this inter-dependency is due to the fact that each of the M voters in vRLS is independent of every other voter.

When rᵢ₁ ≠ rᵢ₂, Equation (10) will no longer hold true. Instead the intersection of the clusters rᵢ₁cⱼ and rᵢ₂cₖ will result in a set whose magnitude can vary anywhere from 0 (i.e. the empty set) to min(|{rᵢ₁cⱼ}|, |{rᵢ₂cₖ}|). This means that for any three clusters, rᵢ₁cⱼ, rᵢ₂cₖ and rᵢ₃cₗ, all from different runs (i.e. rᵢ₁ ≠ rᵢ₂ ≠ rᵢ₃), it will be possible that the intersection of either of the first two clusters with the third cluster will both produce non-empty sets. Therefore, it will not be known if rᵢ₃cₗ should become a node in the graph containing rᵢ₁cⱼ, rᵢ₂cₖ or neither.

A strategy in which the decision of which of two or more existing graphs a node rᵢ₃cₗ is to be added to is determined by the strength (or weight) of the link between that node and any other node that has already been added to the any of the existing graphs was implemented to address the issue.

Between any two different runs, the link strength between any two pairs of points, rᵢcⱼ₁ & rₖcⱼ₂, can be calculated by dividing the size of the intersecting set of documents represented by the two points, by their union. The link strength between any two clusters across different runs can thus be enumerated and a sorted list of such pairs created. This link strength, s, between any two clusters, j1 & j2, in different runs, i & k, is defined as:

s(rᵢcⱼ₁,rₖcⱼ₂)=|rᵢcⱼ₁ ∩ rₖcⱼ₂|/|rᵢcⱼ₁ ∪ rₖcⱼ₂|:i ≠ k̂0≦j1,j2<K (11)

and the sorted list of such pairs, S, will be:

S={pₘₐₓ,pᵢ₋₁,pᵢ, . . . ,pₘₐₓ} [symbol] pⱼ≡(r_{w}cₓ,r_{y}c_{z})̂s(pᵢ)>0̂s(pᵢ₊₁≧s(pᵢ) (12)

In the example embodiment, the restriction that each potentially complete graph, G, can only be formed by taking exactly one cluster from each unique run, is expressed as:

G≡{rᵢcⱼ} [symbol] ∀rᵢcⱼ₁,rₖcⱼ₂ ∈ G, i ≠ k̂0≦i, k<M̂0≦j1,j2<K (13)

Additionally, to avoid constructing trivial graphs, the restriction:

G≡{rᵢcⱼ} [symbol] ∀rᵢcⱼ₁,rₖcⱼ₂ ∈ G, rᵢcⱼ₁ ∩rₖc ≠ { } (14)

was imposed.

The set of K potentially complete graphs may then be created. Assuming that an ordered set of graphs {G} is maintained, then, for each pair, (rᵢcⱼ₁, rₖcⱼ₂) of inter-run clusters in sorted list S, the ordered set of graphs {G} will be searched for the first graph in which both rᵢcⱼ₁ and rₖcⱼ₂ can be members of without violating the aforementioned restrictions [Equations (13) & (14)] on that graph. Upon encountering the first graph, G, for which both Equations (13) & (14) are satisfied by both nodes of inter-run cluster pair (rᵢcⱼ₁, rₖcⱼ₂), the pair is then incorporated into G as a new edge. Conversely, whenever such a pair (rᵢcⱼ₁, rₖcⱼ₂) is encountered that does violate either Equation (13) or (14) (or when {G} is initially empty), it is then simply used as the seed for a new graph. The new graph is then added to the end of the ordered set of graphs. Lastly, the process is repeated for all inter-run cluster pairs in S.

The algorithm above will result in K complete graphs of run-cluster pairs in {G}. In reality, there may be many more than K graphs with the number of nodes steadily decreasing from M down to 1 in the ordered set {G}. To reach the target number of clusters, C, the most complete graphs are gathered iteratively, one group at a time, starting from the complete graphs with M nodes, then the graphs with M-1 nodes, and so on, until the accumulated number of graphs that is at least as large as K is reached.

The actual composite clusters can then be created by constructing the composite cluster centroids out of the individual documents recorded within each cluster (from different runs) associated with the top graph. It should be noted that the assimilation of each document into a composite cluster's centroid takes the form of a “fuzzy” summation, as the number of instances of any single document occurring within the complete graph will vary between M and 1. In other words, a document can in effect partially belong to multiple composite clusters in the example embodiment.

### Term Extraction

For one example of a Term Extraction method which may be utilised by the Term Extractor 306, reference is made Term Extraction Through Unithood And Termhood Unification (Thuy V U, Ai Ti A W, Min ZHANG), contents of which are included by cross reference Proceedings of the 3nd International Joint Conference on Natural Language Processing (IJCNLP-08), India, January 2008.

A general Term Extraction method consists of two steps. The first step makes use of various degrees of linguistic filtering (e.g., part-of-speech tagging, phrase chunking etc.), through which candidates of various linguistic patterns are identified (e.g. noun-noun, adjective-noun-noun combinations etc.). The second step involves the use of frequency- or statistical based evidence measures to compute weights indicating to what degree a candidate qualifies as a terminological unit. There are many methods understood by a person skilled in the art that may improve this second step. Some of them borrow the metrics from Information Retrieval to evaluate how important a term is within a document or a corpus. Those metrics are Term Frequency/Inverse Document Frequency (TF/IDF), Mutual Information, T-Score, Cosine, and Information Gain. There are also other works e.g. A Simple but Powerful Automatic Term Extraction Method. 2^{nd} International Workshop on Computational Terminology, ACL, Hiroshi Nakagawa, Tatsunori Mon. 2002; The C-Value/NC-Value Method of Automatic Recognition for Multi-word terms. Journal on Research and Advanced Technology for Digital Libraries, Katerine T. Frantzi, Sophia Ananiadou, and Junichi Tsujii. 1998, that introduce other methods to weigh the term candidates.

In Term Extraction Through Unithood And Termhood Unification, VU et al introduce a term re-extraction process (TREM) using Viterbi algorithm to augment the local Term Extraction for each document in a corpus. TREM improves the precision of terms in local documents and also increases the number of correct terms extracted. Vu et al also propose a method to combine the C/NC value with T-Score. This NTCValue method, in combining the termhood features used in C/NC method, with T-Score, a unithood feature, further improve the term ranking result.

### Content Alignment

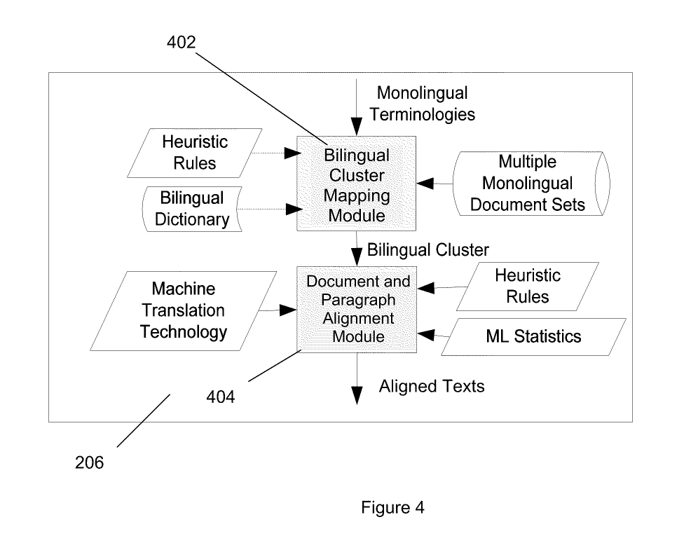

Given all clusters, their respective terminologies, and a pivot language, the Content Alignment Module 206 (FIG. 2) then performs content alignment. FIG. 4 illustrates the schematic diagram of an example embodiment of the Content Alignment Module 206 (FIG. 2). First, a Bilingual Cluster Mapping Module 402 maps the clusters of documents in respective languages to the clusters in the pivot language to form respective bilingual clusters, based on term frequency and/or date distribution, heuristic rules and/or bilingual dictionaries. Further, the Document and Paragraph Alignment Module 404 performs high-level content matching between the bilingual clusters to extract aligned documents or paragraphs. These extracted aligned texts have high similarities in the subject matter cited. Heuristic rules such as, but not limited to, similarities of high frequency terms, time window, etc. may be used in the alignment process.

In the example embodiment, the Bilingual Cluster Mapping Module 402 builds up a relationship network comprising a host of bilingual cluster maps. The Document and Paragraph Alignment Module 404 uses a linear model comprising a diverse set of attributes.which includes e.g. Discrete Fourier Transform (DFT) to measure document similarity based on the monolingual terminologies extracted for each of the documents. This linear model is language independent and utilizes cheap dictionary resources. The Document and Paragraph Alignment Module 404 which mines documents with similar content across two mapped cluster maps obtained from the Bilingual Cluster Mapping Module 402, assuming the chain of frequency of the extracted terms to be a signal and utilises signal processing techniques e.g. DFT, to compare the two frequency distributions, for document alignment purposes.

Document and Paragraph Alignment Module 404 works on two sets of comparable mono-lingual corpora at a time to derive a set of parallel documents. It comprises of three components: candidate generation, attribute extraction, and candidate selection.

### Candidate Generation

The system in the example embodiment first generates a set of possible alignment candidates using filters to reduce the search space. The two filters used are described below:
(a) Date-Window Filter: Constrains the number of candidates by assuming documents with similar content to have a close publication date though they reside in two different corpora.
(b) Title-n-Content Filter: As the Date-Window Filter constrains the alignment candidates purely based on temporal information without exploiting any content knowledge, the number of candidates to be generated is thus dependent on the number of published articles per day instead of basing on the potential content similarity. For this reason, a Title-n-Content filter is further applied to gauge the potential content similarity between two documents. This filter credits alignment candidates whose translation of any of its title word is found in the content of the other document.

### Attribute Extraction

The second step extracts the different attributes for each candidate and computes the score for each individual attributes. The attributes include but are not limited to:
(a) Title-n-Content which scores the similarity of two documents based on the ability to find the translational equivalences between the title and main content of the two documents.
(b) Linguistic-Independent-Unit which is defined as a piece of information written in the same way for different languages
(c) Similarities in Monolingual Term Distribution which is measured based on frequency distribution correlation using Discrete Fourier Transform (DFT)
(d) The number of Aligned Bilingual Terms between two documents
(e) Okapi score (Okapi) (C. Zhai and J. Lafferty, 2001) generated using Lemur Toolkit [A study of smoothing methods for language models applied to Ad Hoc information retrieval, Proceedings of the 24th annual international ACM SIGIR conference on Research and development in information retrieval. Louisiana, United States, 2001].

### Candidate Selection

The final score for each alignment candidate is computed based on a normalization model where all the attribute scores are combined into a unique score. Assuming each attribute is independent, for simplicity, the attribute scores are normalized to make it less sensitive to the absolute value returned by each attribute score. Candidates are then selected based on the computed final score.

Using the aligned texts from Document and Paragraph Alignment Module 404, Bilingual Term Extraction Module 208 (FIG. 2) discovers new bilingual terminologies not found in the bootstrapped bilingual dictionary by using machine learning methods on co-occurrence information, assuming the frequent collocates of two mutual translations in an aligned text with same similar content are likely to be mutual translations. The techniques and algorithms for extracting bilingual terminologies given two aligned texts are not limited to those discussed above. Further, the bilingual terminologies found in this process are used in the example embodiment to augment the bootstrapped dictionary used in the Content Alignment Module 206, iteratively itself until an optimum is found.

### 2. Bilingual Terminology Fusion Module

The Bilingual Terminology Fusion Module 104 (FIG. 1) amalgamates the extracted bilingual terminologies 110 from the Bilingual Terminology Database Generation module 102 to form a multilingual terminology database 114. This database connects the same terminologies expressed in different languages through the terminologies of an Interlingua or identified pivot language. In doing so, it further improves the quality of the extracted bilingual terminologies using the constraints given by a third language. This bilingual terminology fusion module 104 outputs the multilingual terminology database 114 that provides the equivalent translation of a given terminology in all languages processed by the system.

In embodiments of the present invention, in connecting the various Bilingual Terminology Databases 110, the Bilingual Terminology Fusion Module 104 may reduce the redundancies in many-to-many mapping between the plurality of languages by utilizing contextual knowledge to reduce the number of mappings via a pivot language to many language terminology instead.

### 3. Multilingual Indexing Module

The Multilingual Indexing Module 106 uses the multilingual terminology database 114 created by the Bilingual terminology Fusion Module 104 to retrieve multilingual documents and can be implemented without using a direct translation model, such as machine translation or bilingual dictionary, adopted by most of the current query translation multilingual information retrieval systems. In contrast to the example embodiment, such direct translation model systems are characterised by a clear separation between the different languages, where the terminology is first “translated” into the respective multitude of languages before subsequent retrieval using multiple monolingual documents sets.

In the embodiments of the present invention, multilingual information access is achieved through the corpus-based strategy in which multilingual terminologies are first extracted from corpus, organized and integrated in a universal multilingual terminology index object to be used for all language retrieval. Each multilingual index object respresents a unique terminology expressed in different languages and their links to the different documents associated with the index object. Each document is also linked to the aligned documents generated by the Document and Paragraph Alignment Module 404. Monolingual terminology index trees are built for each language and point to the same multilingual index object.

The Multilingual Indexing Module may also include a word index for each language to cater for new terminology not included in the multilingual terminology index.

### 4. Multilingual Retrieval Module

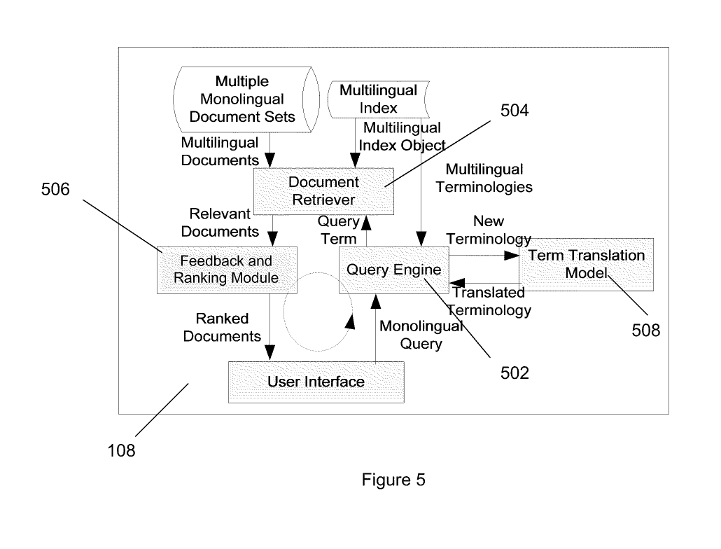

The Multilingual Retrieval Module 108 reads in a monolingual query, analyses the query, determines the query language, looks up the relevant monolingual index tree to obtain the multilingual index object, and uses the multilingual index object to retrieve multilingual documents. FIG. 5 shows the schematic diagram of an example embodiment of the Multilingual Retrieval Module 108.

The Query Engine 502 tunes the query to produce a query term for optimum retrieval performance. It includes, but is not limited to stemming and segmentation of the original query text. Alternatively, should the query term not be found in the relevant monolingual index tree by the Document Retriever 504, the term may returned to the Query Engine 502 and considered to be a new term translated into another language via a bootstrapped dictionary or Term Translation Model 508. The query may be in keyword or natural language.

Next, the Document Retriever 504 uses the query term produced by the query engine 502 to obtain all the documents that correspond to the query. Embodiments of the present invention use the multilingual index object to bridge the language differences between documents. First, the query term is looked up in the monolingual index tree in the determined language. If the query term is found in the monolingual index tree, a multilingual index object is obtained and used to retrieve the multilingual documents via the multilingual index. As described earlier, if the query term is not found, the query term may be returned to the Query Engine 502 and translated, based on a Term Translation Model 508, into an alternative language, before it is subsequently sent to the Document Retriever 504.

Finally, the retrieved multilingual documents are sent to a Feedback and Ranking Module 506 which defines the order among the documents according to their degree of similarity and relevancy to the user query based on some ranking models. The models may be but are not limited to supervised and unsupervised models utilizing various types of evidences including content features, structure features, and query features. The performance of the multilingual retrieval can also be enhanced through an interactive and multi-pass process for the user to refine the query.

### Multilingual Content Presentation System

The semantics of the multilingual document sets after the series of processing as described in module 102, 104, 106 and 108 can be presented in the form of a Multilingual Content Presentation System to provide the user with a visual representation of the document organization in their respective language sets.

The content presentation system seeks to provide a means to explore large collections of multilingual texts through visualization and navigation on content maps generated prior to the searching or browsing operation. The presentation module describes the relationships of the document sets in clusters of terms and documents with rich user interface features to provide the dynamically changing related multilingual information.

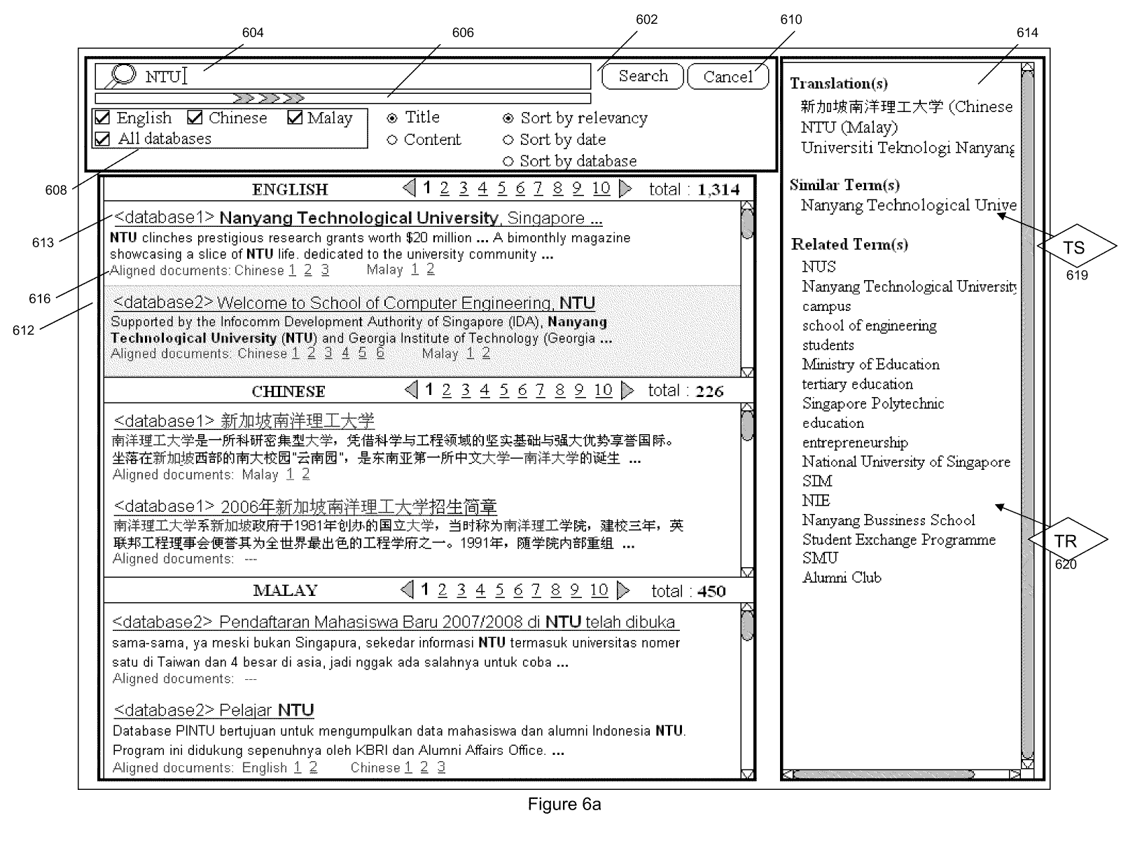

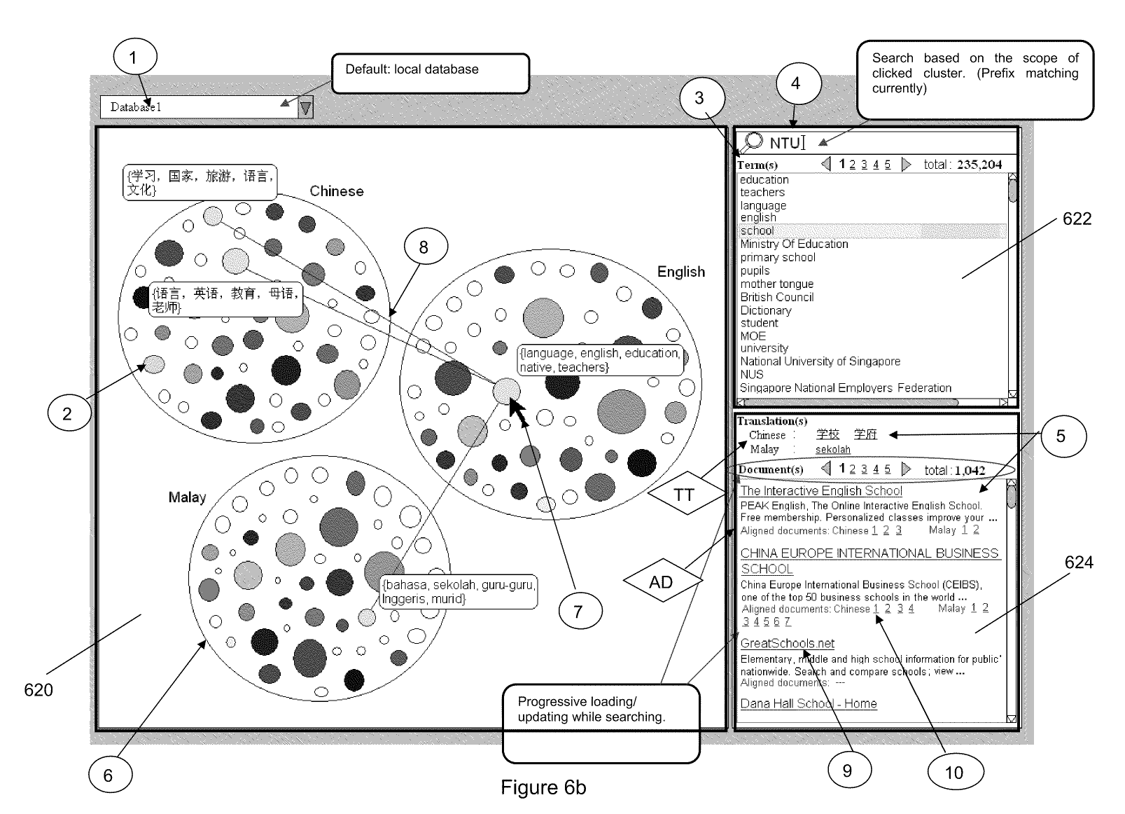

FIG. 6a shows a view of the presentation module in an example embodiment in the text-mode, comprising three main panels.

The input panel 602 allows the user to key in the query in the query box 604 and also to select options such as the search scope options 608, and the sort order of the results. When the query is entered, the user is also presented with a progress bar 606 indicating the progress of the search. The user may also cancel the search at anytime via the cancel button 610.

The document result panel 612 displays a list of all the documents, e.g. 613, which match the query. These results are progressively loaded and updated as the search progresses. The results on display may be generated dynamically based on the select options provided in the input panel 602. For example, if only the English scope is selected in 608, the document result panel 612 will only display the search results from the English document set. The “aligned documents” links e.g. 616 list documents in other languages but with similar content as the retrieved document 613, as identified from the alignment by the Document and Paragraph Alignment Module (compare 404 in FIG. 4).

The Static Text Panel 614 shows a list of all the result terms which are associated with the query in the input box 604. These terms may include translations of the query term, similar terms or related terms. Term Relation List <TR> 618 shows a list of the related terms of the query term in 604. Term Similarity List <TS> 619 shows a list of all the similar terms of the query term in 604.

FIG. 6b show a view of the presentation module in an example embodiment in the graphical cluster mode, comprising three main panels.

The graphical panel 620 displays the overview of the different language repositories. Documents within each repository are organized into different cluster objects, displayed in different sizes and colors. Each cluster object contains documents in a similar domain. Cluster objects representing clusters of similar content across the different languages are displayed in similar colours, while the size of the cluster object represents the relative cluster size within the repositories.

The term info panel 622 panel shows a list of the most representative terms on the selected repository or cluster. The user may further select a particular term to display a list of the multilingual documents associated with the term in the document info panel 624. The document list is progressively loaded and updated as the search is being performed.

The interaction between the panels is explained in the legend below

### Legend

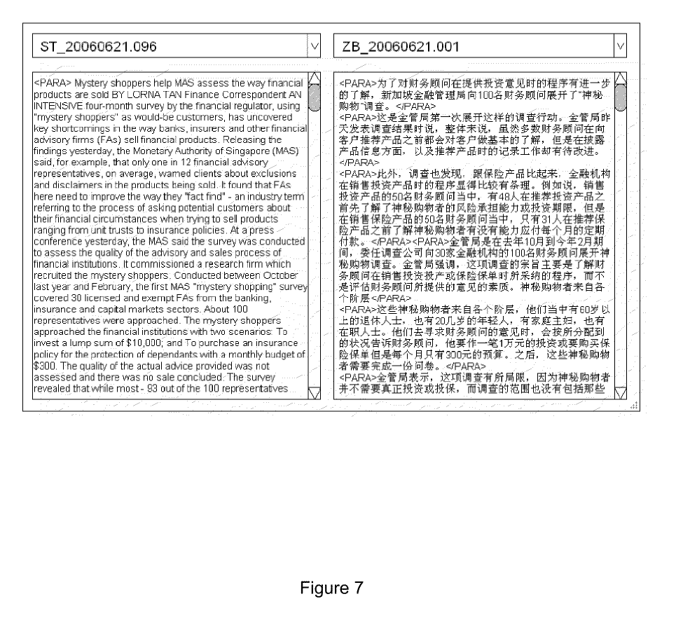

(1) Database List: Provide options to select the scope of the information to be displayed in the graphical panel 620.
(2) Colored cluster bubble: Each bubble corresponds to a cluster of documents within the respective language repostitories. Cluster bubbles in different repository circles share the same color based on the host of bilingual cluster maps.
(3) Terms item: Display the terms with descending rank values in the selected cluster in (2).
(4) Search keyword: Provide a field to enter the interested keyword to constrain the list results in the info panel 622. This may be left blank to show all the results of the selected type in (2) under the scope selected in (1).
(5) Documents item: Display documents associated with the selected term in (3).
(6) Repository circle: Each repository circle corresponds to one language. It envelops the bubbles of different sizes representing the clusters of various numbers of documents in different domains (e.g. education).
(7) Tooltip: When the mouse cursor moves over a cluster, a tooltip will appear to display the feature vector of that cluster. If the mouse is clicked on the cluster, this tooltip will remain on display until the user clicks elsewhere.
(8) Cluster mapping info: When the mouse is clicked on a cluster, the linkage lines between mapped clusters and the feature vector tooltips of the mapped clusters will appear and remain on display until the user clicks elsewhere.
(9) Display Document (View): Double-click the selection allows the selected documents to be viewed in a pop-up window.
(10) Display Aligned Document (View): Double-click the selection allows the aligned documents to be viewed in a pop-up window. An example of this pop-up window is shown in FIG. 7.
<TT> Term Translation: All the term translations of the selected term in (3) based on the Multilingual Terminology Database.
<AD> Aligned Document List: A list of aligned documents.

Embodiments of the present invention seek to provide a new system and method for multilingual information access by deriving a multilingual index from sets of monolingual corpus. It differs from other systems in that multilingual documents are collated as one and there are no distinctive steps of translation and retrieval. This is achieved by multilingual term extraction, fusion and indexing. All queries use the same multilingual index object to retrieve the documents. As the entire index terminologies are attained from the corpus, their translations, if present in the document sets, consequently have a high likelihood of being found in the index object. This solves the out-of-domain problem in using machine translation system and limited lexicon coverage problem in bilingual dictionary. Thus, the embodiments seek to provide an effective system and method for multilingual information access, which can be applied for handling multilingual close-domain data which usually have high similarity in areas-of-interest in the different language dataset.

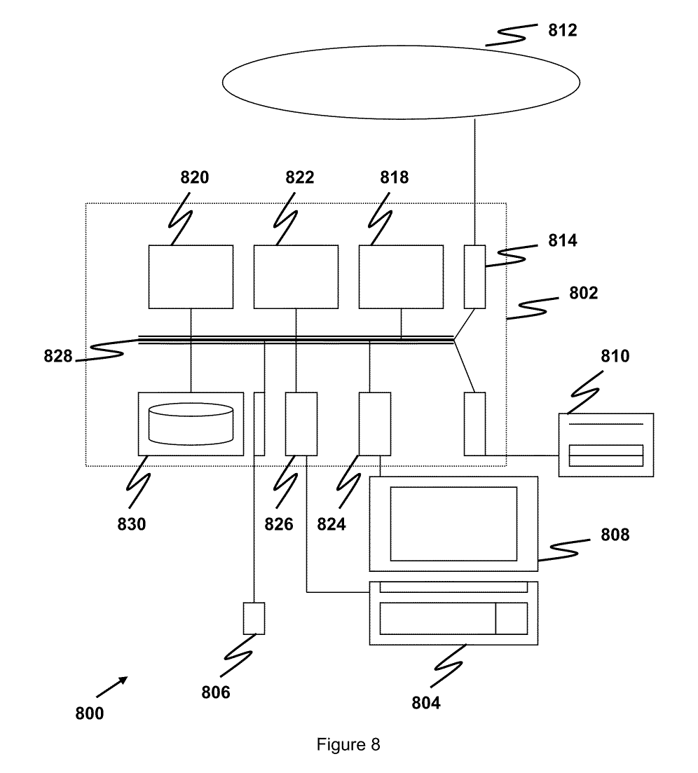

The method and system of the example embodiment can be implemented on a computer system 800, schematically shown in FIG. 8. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via an interconnected bus 828 and in a manner known to the person skilled in the relevant art.

The application program is typically supplied to the user of the computer system 800 encoded on a data storage medium such as a CD-ROM or flash memory carrier and read utilising a corresponding data storage medium drive of a data storage device 830. The application program is read and controlled in its execution by the processor 818. Intermediate storage of program data maybe accomplished using RAM 820.

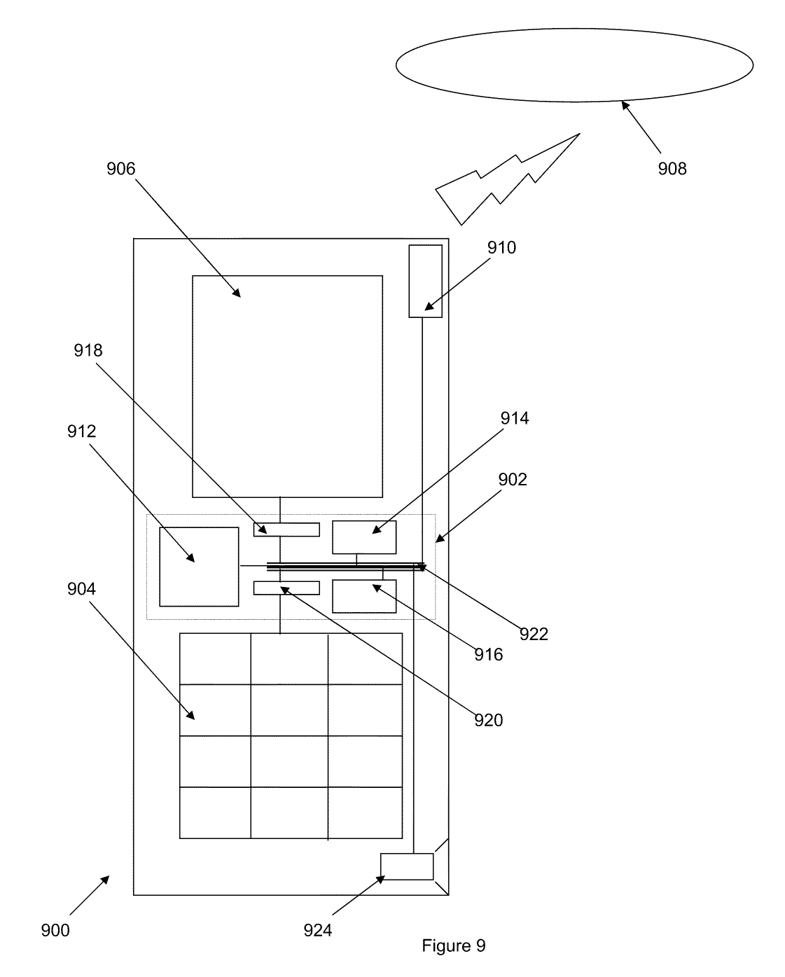

The method of the current arrangement can be implemented on a wireless device 900, schematically shown in FIG. 9. It may be implemented as software, such as a computer program being executed within the wireless device 900, and instructing the wireless device 900 to conduct the method.

The wireless device 900 comprises a processor module 902, an input module such as a keypad 904 and an output module such as a display 906.

The processor module 902 is connected to a wireless network 908 via a suitable transceiver device 910, to enable wireless communication and/or access to e.g. the Internet or other network systems such as Local Area Network (LAN), Wireless Personal Area Network (WPAN) or Wide Area Network (WAN).

The processor module 902 in the example includes a processor 912, a Random Access Memory (RAM) 914 and a Read Only Memory (ROM) 916. The processor module 902 also includes a number of Input/Output (I/O) interfaces, for example I/O interface 918 to the display 906, and I/O interface 920 to the keypad 904.

The components of the processor module 902 typically communicate via an interconnected bus 922 and in a manner known to the person skilled in the relevant art.

The application program is typically supplied to the user of the wireless device 900 encoded on a data storage medium such as a flash memory module or memory card/stick and read utilising a corresponding memory reader-writer of a data storage device 924. The application program is read and controlled in its execution by the processor 912. Intermediate storage of program data may be accomplished using RAM 914.

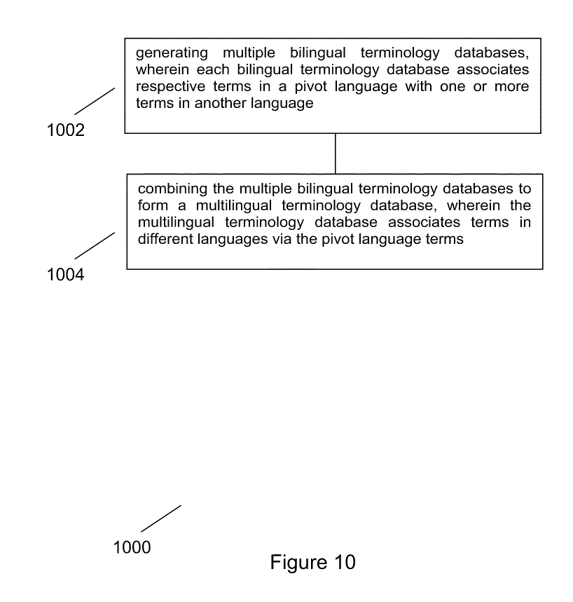

FIG. 10 shows a flowchart 1000 illustrating the method for aligning multilingual content and indexing multilingual documents. At step 1002, multiple bilingual terminology databases are generated, wherein each bilingual terminology database associates respective terms in a pivot language with one or more terms in another language. At step 1004, multiple bilingual terminology databases are combined to form a multilingual terminology database, wherein the multilingual terminology database associates terms in different languages via the pivot language terms.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for aligning multilingual content and indexing multilingual documents, the method comprising the steps of:
generating multiple bilingual terminology databases, wherein each bilingual terminology database associates respective terms in a pivot language with one or more terms in another language; and
combining the multiple bilingual terminology databases to form a multilingual terminology database, wherein the multilingual terminology database associates terms in different languages via the pivot language terms.

2. The method as claimed in claim 1, further comprising indexing the multilingual documents such that each multilingual document is indexed to one or more terms in the pivot language.

3. The method as claimed in claim 1, wherein generating the multiple bilingual terminology databases comprises aligning, for respective bilingual pairs of one of the other languages and the pivot language, the content of documents of each bilingual pair.

4. The method as claimed in claim 3, wherein generating the multiple bilingual terminology databases comprises the steps of:
pre-processing each of the multilingual documents;
extracting respective monolingual terms from each of the pre-processed multilingual documents;
aligning, for respective bilingual pairs of one of the other languages and the pivot language, the content of documents of each bilingual pair; and
generating the multiple bilingual terminology databases based on extracted respective terms from the aligned documents of each bilingual pair.

5. The method as claimed in claim 3, wherein aligning, for respective bilingual pairs of one of the other languages and the pivot language, the content of documents of each bilingual pair comprises the steps of:
building up a relationship network comprising a host of bilingual cluster maps; and
mining documents with similar content across respective pairs of mapped cluster maps.

6. The method as claimed in claim 5, wherein the mining of the documents with similar content across respective pairs of mapped cluster maps comprises assuming a chain of frequencies to be a signal and utilising signal processing techniques such as Discrete Fourier Transform to compare frequency distributions of the respective pairs.

7. The method as claimed in claim 5, further comprising, for each document of a set of documents with similar content, linking said each document to the other documents in the set.

8. The method as claimed in claim 2, wherein indexing the multilingual documents further comprises:
using a plurality of monolingual index trees in respective languages such that each multilingual document is indexed to one or more terms in a corresponding monolingual index tree, and wherein each term in the respective monolingual index trees identifies a multilingual index tree object identifying the associated terms in the different languages via the pivot language terms.

9. A system for aligning multilingual content and indexing multilingual documents, the system comprising:
a bilingual terminology database generator for generating multiple bilingual terminology databases, wherein each bilingual terminology database associates respective terms in a pivot language with one or more terms in another language; and
a bilingual terminology fusion module for combining the multiple bilingual terminology databases to form a multilingual terminology database, wherein the multilingual terminology database associates terms in different languages via the pivot language terms;

10. The system as claimed in claim 9, further comprising
a multilingual indexing module for indexing the multilingual documents such that each multilingual document is indexed to one or more terms in the pivot language.

11. The system as claimed in claim 9, wherein the bilingual terminology database generator comprises a content alignment module for aligning, for respective bilingual pairs of one of the other languages and the pivot language, the content of documents of each bilingual pair.

12. The system as claimed in claim 11, wherein the bilingual terminology database generator comprises:
a pre-processor for pre-processing each of the multilingual documents;
a monolingual terminology extractor for extracting respective monolingual terms from each of the pre-processed multilingual documents;
a content alignment module for aligning, for respective bilingual pairs of one of the other languages and the pivot language, the content of documents of each bilingual pair; and
a bilingual terminology extractor for generating the multiple bilingual terminology databases based on extracted respective terms from the aligned documents of each bilingual pair.

13. The system as claimed claim 11, wherein the content alignment module builds up a relationship network comprising a host of bilingual cluster maps; and mines documents with similar content across respective pairs of mapped cluster maps.

14. The system as claimed in claim 13, wherein the mining of the documents with similar content across respective pairs of mapped cluster maps comprises assuming a chain of frequencies to be a signal and utilising signal processing techniques such as Discrete Fourier Transform to compare frequency distributions of the respective pairs.

15. The system as claimed in claim 13, wherein, for each document of a set of documents with similar content, the content alignment module further links said each document to the other documents in the set.

16. The system as claimed in claim 10, wherein the multilingual indexing module uses a plurality of monolingual index trees in respective languages such that each multilingual document is indexed to one or more terms in a corresponding monolingual index tree, and wherein each term in the respective monolingual index trees identifies a multilingual index tree object identifying the associated terms in the different languages via the pivot language terms.

17. A computer readable data storage medium having stored thereon computer code means for aligning multilingual content and indexing multilingual documents, the method comprising the steps of:
generating multiple bilingual terminology databases, wherein each bilingual terminology database associates respective terms in a pivot language with one or more terms in another language;
combining the multiple bilingual terminology databases to form a multilingual terminology database, wherein the multilingual terminology database associates terms in different languages via the pivot language terms; and

18. A system for presenting multilingual content for searching, the system comprising:
a display;
a database of indexed multilingual documents, wherein each multilingual document is indexed to one or more terms in a pivot language and such that terms in different languages are associated via the pivot language terms;
wherein the display is divided into different sections, each section representing a plurality of clusters of the indexed multilingual documents in one language;
wherein respective clusters in each section are linked to one or more clusters in another section via one or more of the pivot language terms; and
visual markers for visually identifying the linked clusters in the different sections.

19. The system as claimed in claim 18, wherein the visual markers comprise a same display color of the linked clusters.

20. The system as claimed in claim 18, wherein the visual marker comprises displayed pointers between the linked clusters in response to selection of one of the clusters.

21. The system as claimed in claim 18, further comprising text panels displayed on the display for displaying terms associated with a selected cluster.

22. The system as claimed in claim 21, further comprises another text panel for displaying links to documents in the selected cluster for a selected one of the displayed terms.

23. The system as claimed in claim 22, wherein said another text panel for displaying links to documents further displays, for each document in the selected cluster or returned as search results, links to similar documents in other languages.
